(19) United States
(12) Patent Application Publication
(10) Pub. No.: US 2003/0235281 A1
(43) Pub. Date: Dec. 25, 2003

(54) Method and system for providing secure access to a telephone service

(75) Inventors: L. Lloyd Williams, Kanata (CA); Alexander Markman, Thornhill (CA); David Edward Johnston, Whitby (CA)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(73) Assignee: BELL CANADA, Montreal (CA)

(21) Appl. No.: 10/178,868

(22) Filed: Jun. 24, 2002

(51) Int. Cl. H04M 3/00; G06F 15/173

(52) U.S. Cl. 379/196; 709/224

(57) ABSTRACT

A method and apparatus for authenticating calling parties prior to call connection at a service facility uses the correlation of the call with a security message received over a data network. The correlation is made possible with an encoded string inserted into a field (such as the user-to-user information (UUI) field) of a call set-up signaling message used to initiate the call, and a correlate of the encoded string inserted into the security message. The authentication is provided at an authentication site that is logically separate from the service facility. The call is first connected to the authentication site, an authentication procedure is preferably selected and customized, and then performed. A security message is generated that includes information related to the client and the encoded string. The call is then disconnected from the authentication site, and reconnected to the service facility.

### CROSS-REFERENCE TO RELATED APPLICATIONS

This is the first application filed for the present invention.

### MICROFICHE APPENDIX

Not applicable.

### TECHNICAL FIELD

The present invention relates to the field of telecommunications network security and, in particular, to a method and apparatus for providing secure telephone access to service facilities by correlating a telephone call with a security clearance message delivered through a parallel network at substantially the same time.

### BACKGROUND OF THE INVENTION

The public telephone network is a preferred medium for providing access to information and services. As is known in the art, caller authentication in this medium is generally provided using personal identification numbers input by the caller using the telephone keypad, and/or voice identification where feasible.

Although it is desirable to separate user authentication from service sites, to date there has been no practical solution for enabling such a separation. The separation is desirable for a number of reasons. First, if a posted access number is simply an authentication site, no amount of “hacking” around security barriers will provide access to content of a service site. Second, it permits service site access numbers to be concealed from the general public. In fact, the service access can be arranged using undialable access codes, such as switch and trunk identification codes, which discourages unauthorized access attempts. Third, it allows service providers to concentrate on service provision and leave security and authorization in the hands of an authentication authority dedicated exclusively to the purpose.

So while it is obvious that maintaining a separation between authentication and access to secured content/services improves security, secured telephone access has not thus far been able to provide a substantial separation between these two types of interaction, principally because of risks of someone circumventing the former. Consequently, the major difficulty lies with discerning authenticated calls from those that circumvent the authentication. Even if the service facility is not a dialable number, the routing number of the service facility can potentially be inserted by any of numerous service nodes in the PSTN that have obtained the routing number, and so calls sent to the service facility cannot be known to be authenticated. As call control signaling messages conform to established signaling systems, and so are not readily expansive, the call control signaling messages used to establish a call to the service facility cannot, according to the prior art, carry necessary security information. Furthermore, as the call control signaling messages do not always uniquely identify calls, as is known in the art, the call control signaling messages cannot be reliably indexed by messages sent over a parallel network between the security site and the services facility. There is therefore no known way to provide secure separation of authentication and access provision over telephone lines in the PSTN.

### SUMMARY OF THE INVENTION

An object of the present invention is therefore to provide a method and system for providing secure access to a service facility over a connection established through a switched telephone network.

Accordingly, the method provided involves sending to a service facility a security message regarding an authenticated calling party during the time taken to disconnect the caller from a security site and to establish the call connection path to the service facility. The security message and call are correlated using encoded strings contained in both the security message, and a call control signaling message used to establish the call connection path to the service facility.

Advantageously, the security site can use any information contained in call control signaling messages used to establish a received call, to select an authentication procedure for the caller. The security site can also request further information from calling parties elicited by voice prompts. Any or all of the information pertaining to a call can be forwarded by the security site to the service facility in the security message.

Also advantageously, a single authentication site that is separate from the service facility can provide authentication services for a plurality of service facilities.

Accordingly, calls received at a service facility which were authenticated by the security site, are differentiated from unauthenticated calls with the correlation of the security message with the call set-up signaling message used to establish the call to the service facility.

### BRIEF DESCRIPTION OF THE DRAWINGS

Further features and advantages of the present invention will become apparent from the following detailed description, taken in combination with the appended drawings, in which:

FIG. 1 is a block diagram illustrating principal elements in a system in accordance with the invention;

FIG. 2 is a call flow diagram illustrating principal steps involved in establishing a call to a service provider that is refused for failing authentication, using the system illustrated in FIG. 1;

FIG. 3 is a call flow diagram illustrating principal steps involved in establishing a call to a service provider authenticated and correlated with a security message, using the system illustrated in FIG. 1;

FIGS. 4a,b form a call flow diagram illustrating principal steps involved in establishing a call to a voice access server (VAS) authenticated and correlated with a security message, in the system illustrated in FIG. 1;

It should be noted that, throughout the appended drawings, like features are identified by like reference numerals.

### DETAILED DESCRIPTION OF THE PREFERRED EMBODIMENT

The present invention provides a system and method for correlating security messages received over a data network with a call set-up signaling message used to establish a connection through a switched telephone network to a service facility. The correlation provides a means for identifying a level of authentication of a calling party prior to the establishment of the call. An encoded string (ES) is inserted into a field in the call set-up signaling message that is not generally used for call control purposes. A correlate of the encoded string is inserted into the security message. The calling party is preferably authorized to access services or information in accordance with the level of authentication indicated in the security message, in accordance with some applications of the invention. In accordance with an embodiment of the invention, the call control network is a common channel signaling (CCS) network using signaling system 7 (SS7) standard signaling. Call set-up signaling messages are therefore integrated services digital network-user part (ISUP) initial address messages (IAMs). Consequently the field may be the User to User Information (UUI) field, or any other available field. The field may also be calling party information that almost always uniquely identifies the call. In the event that two calls with the same calling party information are presented to a service facility, both calls may be discarded for security purposes.

System Overview

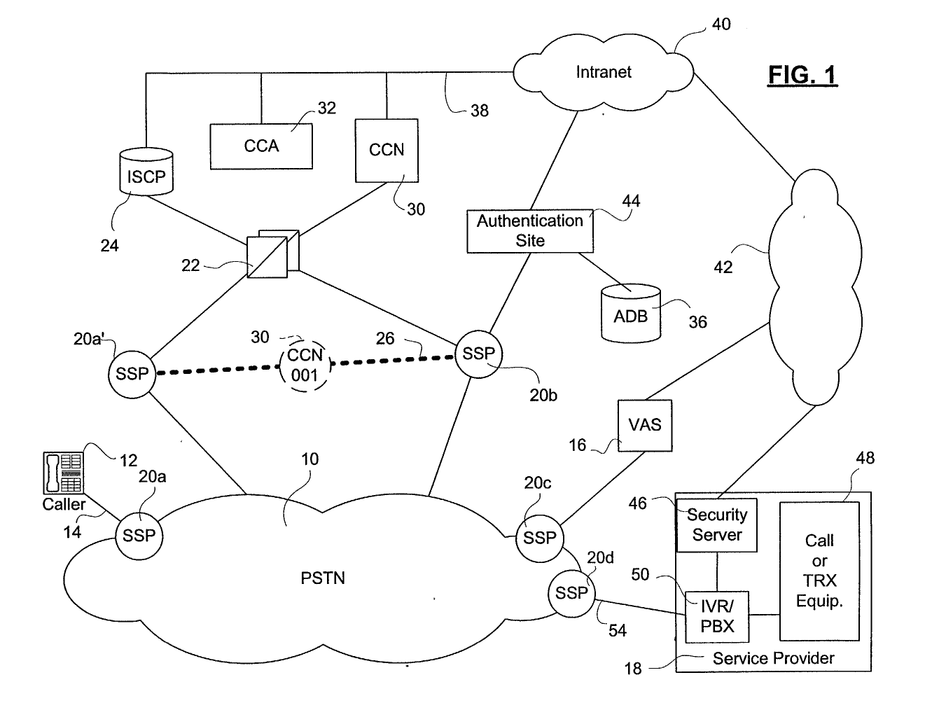

As is schematically illustrated in FIG. 1, a public switched telephone network (PSTN) 10 interconnects a telephone 12 through subscriber line 14 to a Voice Access Server (VAS) 16 and a service provider 18.

As is known in the art, the PSTN 10 includes a plurality of service switching points (SSPs) 20a,a′,b,c,d, only five of which are illustrated. The SSPs 20a,c,d serve respective pluralities of subscriber lines. The SSP 20a, for example, serves a subscriber line 14 of a calling party's telephone set 12. The SSPs 20c,d each serve telephony equipment (the VAS 16 and the service provider 18, respectively) over a primary rate interface (PRI) channel, in a manner known in the art. The SSPs 20a and 20a′ are so named because, for the purposes of illustration, hereinafter they will be referred to as if the two SSPs 20a,a′, along with the intervening PSTN 10, were collapsed to a single switch SSP 20a*. This simplification facilitates the presentation of the many components in the call flows that follow.

The SSPs (generically referred to as 20) are connected to (mated) signal transfer points (STPs) 22; The STPs 22 are also connected to an intelligent service control point (ISCP) 24. Some of the signaling links in the PSTN 10 are enhanced ISUP (E-ISUP), such as trunks 26, as explained in Applicant's U.S. Pat. No. 6,226,289 which issued on May 1, 2001, the specification of which is incorporated herein by reference. Call control signaling for controlling each E-ISUP trunk is routed through a virtual switching point. A call control node (CCN) 30 serves as the virtual switching point in one or more E-ISUP trunks. In this example, CCN 30 is a virtual switching point in E-ISUP trunk 26. Call control application (CCA) 32 directs the CCN 30 in all of its operations.

The ISCP 24, call control application 32, CCN 30, and an authorization database (ADB) 36 are interconnected, for example, by a local area network (LAN) 38, which is connected by an intranet 40 to the Internet 42. The Internet 42 is one example of a data network that may be used for transmitting the security message in accordance with the invention. The Internet 42 is connected to the VAS 16, and a security server 46.

The VAS 16 is adapted to receive calls through primary rate interface (PRI) channels of at least one ISDN trunk. It is capable of playing announcements to, and collecting digits or voice responses from, calling parties. A VAS 16 may be adapted to perform conference bridging and equipped with access application servers to enable a variety of enhanced service features.

The security server 46 preferably exchanges information with call or transceiver (TRX) equipment 48, as will be explained further below. A private branch exchange (PBX) 50, which is an exemplary call distributor telephony device, receives calls from the PSTN 10 over an integrated services digital network (ISDN) trunk 54, distributes received calls to call or TRX equipment 48, and exchanges messages with the security server 46. As will be understood by those skilled in the art, a centrex, a PBX, or numerous other devices adapted to distribute received calls to a plurality of internal lines could also be adapted to serve as a call distributor, in accordance with the invention.

An authentication site 44 is adapted to terminate calls and perform similar functions to that of a VAS, such as VAS 16. In particular, the authentication site 44 is adapted to interact with the ADB 36 in order to perform authentication procedures and to evaluate responses from calling parties. The authentication site 44 and the ADB 36 preferably select and customize authentication procedures, and can, advantageously, use calling party identification information, such as calling line identity (CLID), in order to do so. Responses to voice prompts may also be used to further select and customize the authentication procedure.

CCN 30 is capable of effecting the release and set-up of call connections passing through the E-ISUP trunk in which it is a virtual switching point. Under the direction of the call control application 32, the call control node 30 is adapted to provide access to call connections in order to provide enhanced service features. According to design preferences, the call control application 32, authentication database 36, and authentication site 44 may perform different steps of the method of this invention, including generating the ES, formulating and sending the security message, and effecting the re-connection of the call after it is connected to the authentication site 36.

Exemplary Methods

There are many different ways that the security message received by a service facility can be used to improve security features for a correlated call. Most importantly, the security messages are used to screen out callers who inadvertently or intentionally access the service provider 18 without authorization. Security information contained in the security message may be displayed at a display terminal of a service provider agent selected to receive the call to simplify the task of a service provider agent, and to make the service provider operations more efficient, for example. A second method involves routing messages to specific service provider agents according to the outcome of the authentication procedure. In much the same way, the security messages can also enable service features for calls to a VAS. For the present embodiments, voice access servers and service providers are merely intended as illustrative examples of telephony devices. A plain old telephone service (POTS) subscriber or key telephone system user may equally benefit from security measures enabled by the present invention.

Information supplied by security messages correlated with incoming calls can augment the provisioning of services to calls in accordance with the present invention, by identifying high risk calls to be recorded or otherwise monitored, prior to acceptance of the call. For calls to a VAS, the VAS may use caller supplied information needed to authenticate the caller, to expedite the service feature or to access the caller's account or profile, for example.

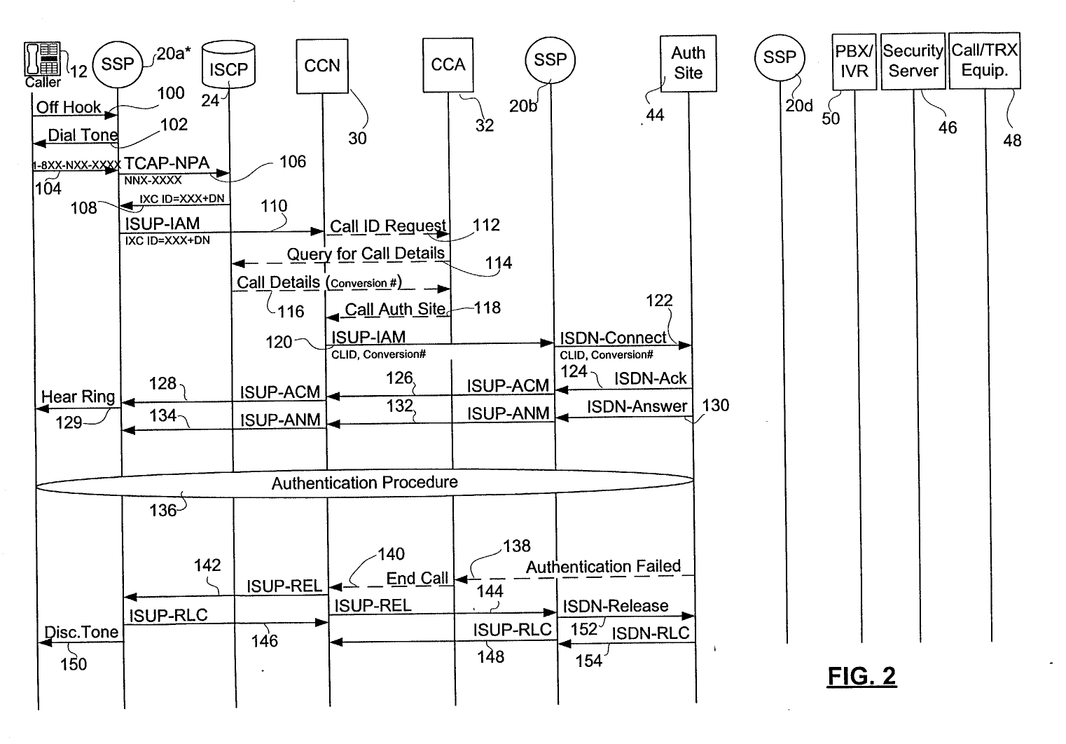

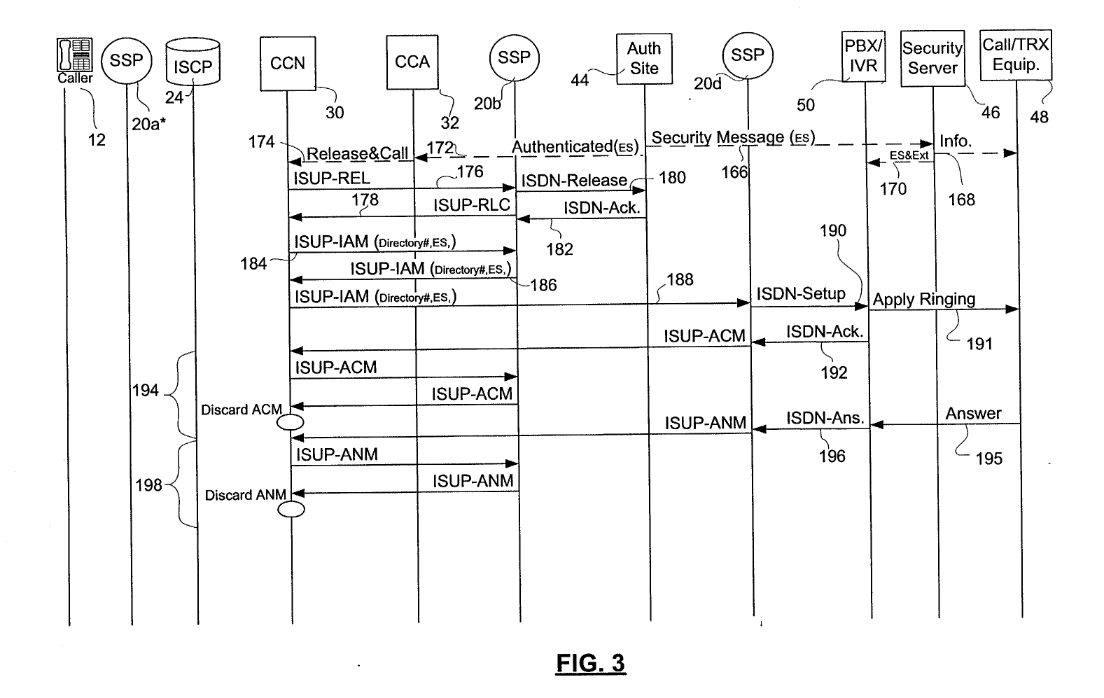

One method for providing a correlated security message with a call is illustrated in FIGS. 2 and 3. FIG. 2 illustrates principal messages exchanged between network elements when an unauthorized caller attempts to establish a call to a service provider. In step 100, the calling party's telephone 12 goes off-hook. This is detected by a SSP in the PSTN 10 (SSP 20a) that serves the subscriber line 14. As will be recognized by those skilled in the art, the SSP 20a* is not a single switch in the PSTN 10, but represents a plurality of such switches. The SSP 20a* applies a dial tone to the subscriber line 14, in step 102. A “1-800” number is dialed by the caller (step 104), and the SSP 20a* issues a TCAP query to the ISCP 24 (step 106). The query includes the 1-800 number and enough information to identify the calling party's numbering plan area (NPA), commonly referred to as an “area code”, using one of: caller line identity (CLID), automatic number identification (ANI) information, and trunk information. The ISCP 24 identifies the NPA of the calling party, and selects an inter-exchange carrier that handles calls in the identified NPA. In step 108, the ISCP 24 replies to the query with a TCAP response including the directory number (DN) initially dialed, and an inter-exchange carrier identifier (IXC ID). The response prompts the SSP 20a* to reserve an E-ISUP trunk 26, generate an ISUP-IAM, and send it to the CCN 30, in a manner known in the art, as explained in Applicant's patent incorporated herein by reference. The IAM is sent in step 110.

The CCN 30 receives the IAM, and queries the call control application (CCA) 32 for call identification (step 112). The CCA 32 formulates and sends a query to ISCP 24, requesting conversion of the DN (step 114). In step 116, the ISCP 24 replies to the query sending the conversion number, (example: Bellcore TR 3511) in a manner known to those skilled in the art. The conversion number is a directory number of the authentication site, because the service provider subscribes to an enhanced service feature requiring the authentication services of the authentication site 44, and so the CCA 32 directs the CCN 30 to connect the call to the authentication site 44 (step 118). The CCN 30 inserts the DN as a re-direct number into the received IAM and performs changes to the Point Codes in a manner known in the art. The CCN 30 then sends the IAM to SSP 20b (step 120).

Upon receipt of the IAM, the SSP 20b translates the conversion number, which directs it to terminate the call to the authentication site 44, with an ISDN-setup message (step 122). The authentication site 44 acknowledges the setup message (step 124), which causes the SSP 20b to return an ISUP-address complete message (ACM) to the previous switch in the call connection (step 126), which in this example is the CCN 30. The CCN 30, on receipt of the ACM, forwards the ACM to the previous switch, SSP 20a* (step 128), and the calling party hears ringing (step 129). The authentication site 44 answers the line, generating an ISDN-Answer message (step 130) that is sent to the SSP 20b. The SSP 20b forwards an ISUP-Answer Message (ANM) to the CCN 30 (step 132), the CCN 30 does the same (step 134).

The authentication site 44 then performs an authentication procedure selected in dependence upon the CLID or other available calling party identification information, in order to authenticate the calling party and authorize the calling party to access a certain level of service or information. The authentication procedure (step 136) preferably involves at least one announcement played to the calling party, and at least one reply from the calling party, which may include input of a sequence of digits, or a voice pattern. It should be understood that the present invention is not limited to dual tone multi-frequency signals and/or voice signals. The calling party could also be asked to convey any audio signal or message over a parallel network, for example. The digits or voice pattern are collected by the authentication site 44, and forwarded to the ADB 36 for analysis (not shown). In this example, the ADB 36 returns a negative authorization message to Authentication Site 44, and after a call rejection prompt is played to the user, the call rejection message is forwarded to the CCA 32, indicating that the calling party is not authorized to access any services of the service provider. The CCA 32 responds by directing the CCN 30 to release the call (step 140). The CCN 30 thus issues ISUP-Release messages to SSPs 20a*,b, in steps 142,144 respectively. The SSPs 20a*,b return respective ISUP-Release Complete (RLC) messages (steps 146,148 respectively). In step 150, the SSP 20a* applies a dial tone to the subscriber line 14. In step 152, the SSP 20b sends an ISDN-release message to the authentication site 44, which is acknowledged in step 154.

FIG. 3 illustrates, in the same situation as assumed in FIG. 2, a successful authentication leading to the sending and correlating of a security message with the call. If the ADB 36, in response to the request for authentication of step 138 in FIG. 2 had been successful, the steps of FIG. 3 would have ensued.

After the Authorization Site 44 authenticates the caller using authentication information contained in the ADB 36, and retrieves any information related to the calling party that is associated with the service provider 18, the Auth site 44 sends, in at least one security message (step 166) that includes the retrieved information, the level of authorization (if applicable) and a call identifier, for example the ES that it generates. The security server 46 receives the security message, and prepares for receipt of the authorized call. For example, the security server may select an internal line of the service provider facility available to receive the call (which, in certain embodiments requires a query to the PBX 50), and sends relevant information to the call or TRX equipment 48 (step 168).

Meanwhile, the Auth site 44, after sending the security message in step 166, issues an authenticated call message including the ES and a service provider directory number retrieved from the ADB 36 to the call control application 32 (step 172). The CCA 32 directs the CCN 30 to release the call connection path to the authentication site 44, and re-connect the call to the service provider directory number (step 174). Alternatively, the service provider directory number can be supplied by the service provider in an acknowledgement message for the service provider security server 46.

The CCN 30 therefore issues an ISUP-Release (REL) message to SSP 20b (step 176). This prompts the SSP 20b to return a RLC message (step 178), and to issue an ISDN-Release message to the authentication site 44 (step 180). The ISDN-Release message is acknowledged (step 182) and, in step 184, the CCN 30 issues an IAM containing the service provider's directory number. The IAM is received by SSP 20b translated, and forwarded (step 186) through the PSTN 10 towards the SSP 20d. In a manner known in the art, the call is advanced hop-by-hop through the PSTN 10. The SSP 20dreceives the IAM, translates the DN, determines that the call is to be terminated at the PBX 50 and, in step 190, issues an ISDN-Setup message to the PBX 50. The PBX 50 receives the advisory of the incoming call, extracts the ES, and performs any required authentication that the call is an authorized call. The PBX 50 then switches the call to the extension of the selected facility, causing the selected facility's line to ring (step 191). The ISDN set-up message is acknowledged by the PBX 50 (step 192), prompting the SSP 20dto issue an address complete message (ACM) to the previous SSP in the call connection path. This ACM is relayed back in step 194 to SSP 20b and finally to the CCN 30, in turn. The CCN 30 discards the ACM, not relaying it further, as the call connection path to the calling party is already established.

The facility takes the call, and in so doing generates an off-hook signal (step 195) that is detected by the PBX 50, which prompts the PBX 50 to issue an ISDN-ANM to the SSP 20d(step 196). Much as the ACMs cascaded back along the call connection path, ANMs are relayed through the PSTN 10, to the SSP 20b, and to the CCN 30, where it is discarded in steps 198. The call is thus completed and normal call termination procedures apply.

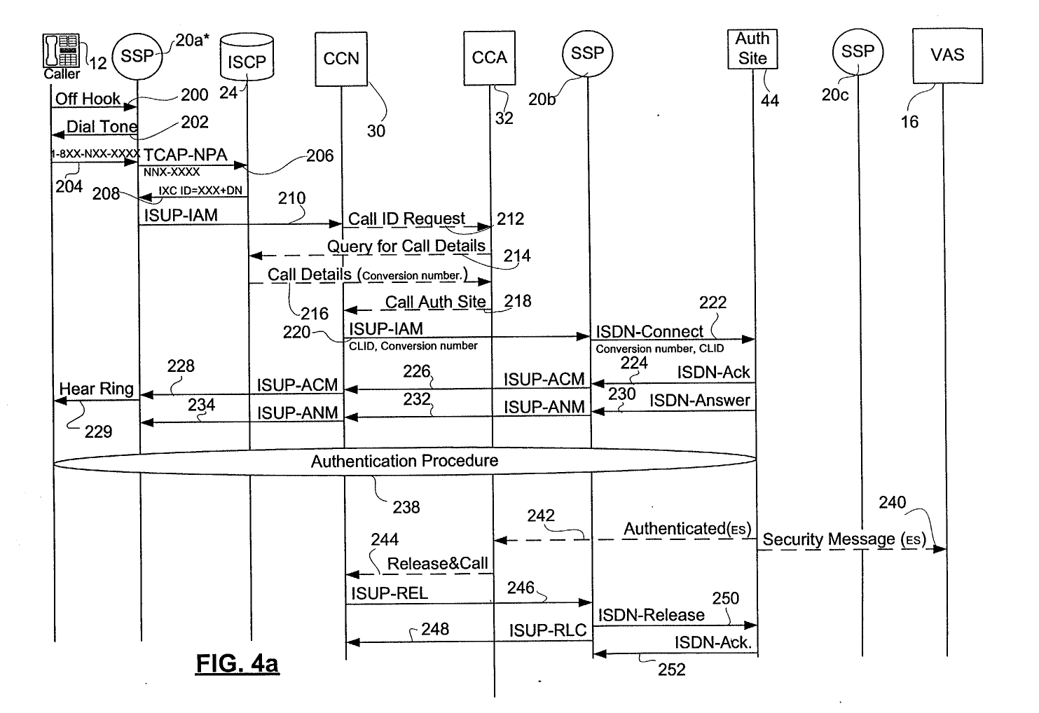

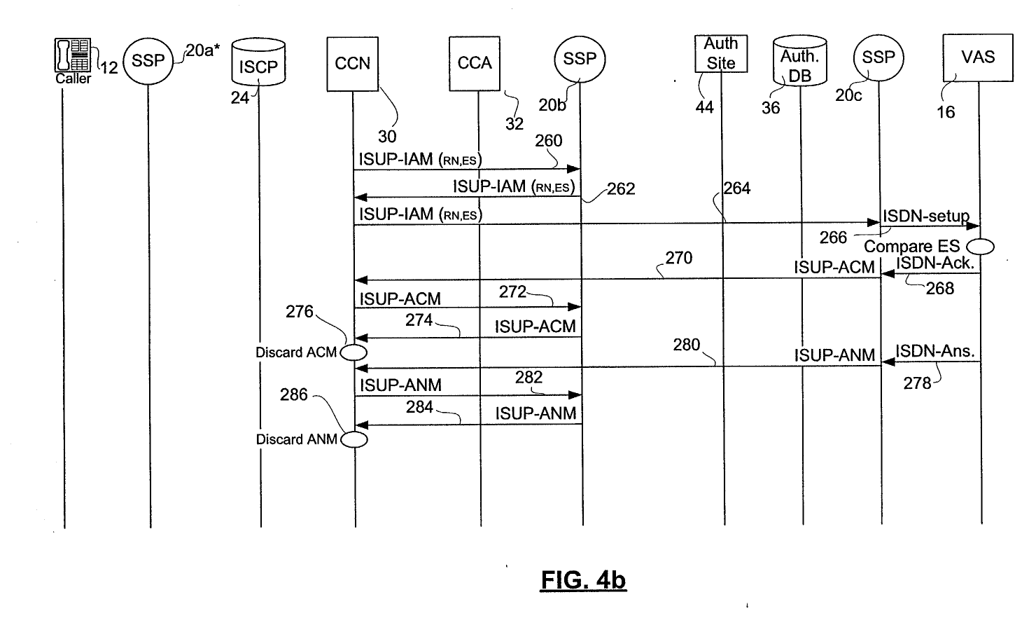

FIGS. 4a,b form a call flow diagram illustrating principal steps involved in providing authentication services to the VAS 16.

Steps 200-238 are the same as steps 100-138 of FIG. 2, and so their description will not be repeated here. After the digits and/or voice pattern supplied by the calling party during authentication process in step 238 are collected by the authentication site 44, the authentication site 44 uses the ADB 36 to evaluate the calling party's response, in order to authenticate the calling party (step 240). The ADB 36 receives from the authentication site 44 the relevant call-specific information required to complete the authentication. The authentication site 44 then waits for a return value from the ADB 36 indicating the success or failure of the authentication procedure. The authentication site 44 may be adapted to play different announcements depending on: the level of security required for, or requested by, the calling party; other information provided by the calling party; or the calling party identification information, prior to or after sending the request for authentication to the ADB 36.

In this example, the result of the authentication request is that the calling party is permitted to access some level of service or information. The authentication site 44 therefore selects a service facility to handle the call using any of the following: a response from the calling party supplied to the authentication site, information received in a call set-up signaling message used to establish the call to the authentication site, the result of the authentication procedure, and information regarding the availability of the service facility to receive the call. As the calling party is authenticated, a pass response is returned for the authentication request. Having ascertained the level of authentication of the calling party, the authentication site 44 requests the call control application 32 disconnect the call connection to the authentication site 44, and re-connect it to a routing number that it supplies along with the ES that it generated on receiving the pass response (step 242). The authentication site 44 also generates and sends an encoded security message over the Internet 42, to the VAS 16 (step 240). The VAS 16 preferably uses the security message to select and customize the service or information provision to be performed for the calling party. The VAS 16 also uses the ES to verify that the subsequently received call is the expected call containing the correlate ES. In step 244, the call control application 32 initiates the reconnection of the call with a release and reconnect call command to the CCN 30. Consequently, CCN 30 issues a REL message to the SSP 20b requesting the release of the appropriate trunk (step 246), which is acknowledged with a RLC (step 248). The SSP 20b, in turn, issues an ISDN-Release message to the authentication site 44 (step 250), and receives an acknowledgement message in reply (step 252).

As illustrated in FIG. 4b, the release of the connection path to the authentication site 44 prompts the CCN 30 to issue an IAM to connect the call to the VAS 16 (step 260). The IAM is received at the SSP 20b, the routing number is translated and, consequently, the SSP 20b forwards eth call through the PSTN 10, to the SSP 20c, which serves the VAS 16 (step 264). The SSP 20c issues an ISDN set-up message containing the ES to the VAS 16 (step 266). The VAS 16 returns an acknowledgement (step 268). The acknowledgement triggers the SSP 20c to issue an ACM which re-traces the call connection path through the PSTN 10, and is forwarded to the SSP 20b, in step 272, and from there to the CCN 30, in step 274. The CCN 30, having generated the IAM message, receives the ACM, and discards (step 276) it without forwarding it to the previous switch in the call connection (SSP 20a*), which is already in a call stable state. Meanwhile, the VAS 16 compares the ES extracted from the ISDN setup message with the ES received in the security message, and determines that the call is an authorized call. When the VAS's 16 line is answered, an ISDN answer message is sent to the SSP 20c (step 278). The SSP 20c then initiates a cascade of ANMs through the PSTN to SSP 20b (step 282), and finally to CCN 30 (step 284), where it is discarded (step 286). The connection between the calling party and the VAS 16 is now underway, and the selected and customized service or information is delivered.

If an IAM is received by the VAS 16 not containing an ES in the UUI field, or there is no corresponding security message, the call may be released, or the call may be terminated to an agent who handles unauthorized callers.

In other embodiments of the invention, the ES sent in the security message is not identical to that which is inserted into the UUI field of the IAM used to initiate the correlated call, but rather the content of the UUI field is related to the ES in a bijective correspondence. The bijective correspondence is all that is required for the security message to be unambiguously correlated with the call. The advantage of using a bijective correspondence (other than identity) is that, if it remains secret, knowledge of either the ES, or the content of the UUI field alone, will not permit the construction of the other message.

The embodiment(s) of the invention described above is (are) intended to be exemplary only. The scope of the invention is therefore intended to be limited solely by the scope of the appended claims.

We claim:

1. A method of providing secure access to a service facility with a connection established through a telephone network, comprising steps of:
receiving a call from a calling party at an authentication site;
determining at the authentication site if the calling party is authorized to access the service facility;
disconnecting the calling party from the authentication site and re-connecting the calling party to the service facility using a call set-up signaling message containing an encoded string in a field not generally used for call control purposes, if the calling party is authorized;
sending a security message containing a correlate of the encoded string to the service facility through a parallel network, if the calling party is authorized; and
correlating the security message with the call using the encoded string and the correlate of the encoded string prior to permitting access to the service at the service facility.

2. A method as claimed in claim 1 further comprising a step of releasing the call to the authentication site if the calling party is not authorized.

3. A method as claimed in claim 1 wherein the step of determining comprises an initial step of selecting an authentication procedure.

4. A method as claimed in claim 3 wherein the step of selecting comprises steps of:
extracting calling party information from a call setup signaling message used to establish the call to the authentication site; and
analyzing the calling party information to select an authentication procedure.

5. A method as claimed in claim 3 wherein the step of determining further comprises a step of customizing the selected authentication procedure using information provided in call control signaling used to establish the call to the authentication site.

6. A method as claimed in claim 1 wherein the step of performing comprises steps of:
playing a pre-recorded announcement to prompt the calling party to supply information; and
collecting the supplied information.

7. A method as claimed in claim 6 wherein the step of performing further comprises steps of:
using the supplied information to select another prerecorded announcement;
playing the selected other pre-recorded announcement; and
collecting more supplied information.

8. A method as claimed in claim 6 wherein the step of performing further comprises a step of applying a voice recognition program to a voice pattern which forms at least a part of the supplied information.

9. A method as claimed in claim 1 wherein the step of performing further comprises a step of analyzing a sequence of numbers which forms at least a part of the calling party supplied information.

10. A method as claimed in claim 1 wherein the step of disconnecting comprises a step of sending a message that instructs the call control node to disconnect a leg of the call connected to the authentication site, and re-connect the call to the service facility.

11. A method as claimed in claim 1 wherein the step of disconnecting comprises a step of selecting a routing number of the service facility according to at least one of: a response from the calling party supplied to the authentication site; information received in a call set-up signaling message used to establish the call to the authentication site; the result of the authentication procedure; and information regarding the availability of the service facility to receive the call.

12. A method as claimed in claim 1 wherein the step of disconnecting comprises a step of sending a message containing the encoded string from the authentication site to a switch in the call's connection path adapted to release and re-connect the call to the service facility requesting the re-connection of the call.

13. A method as claimed in claim 12 wherein the step of sending a message comprises a step of formulating and sending an integrated services digital network-user part (ISUP) message to a switch serving the authentication site.

14. A method as claimed in claim 12 further comprising an initial step of routing the call to the authentication site through a call control node controlled by a call control application, wherein the step of sending a message comprises a step of formulating and sending a message to the call control application.

15. A method as claimed in claim 1 wherein the step of sending a security message comprises steps of:
generating the security message;
encoding the security message; and
transmitting the security message over a public data network, to the service facility.

16. An authentication site for controlling telephone access to a service facility, comprising: a first interface with a telephone network adapted to receive a call; and
a processor adapted to:
perform an authentication procedure with a calling party over a call connection path through the first interface in order to determine a security status of a calling party;
effect the re-connection of the call by sending a call set-up signaling message, containing an encoded string (ES), to the service facility, if the calling party is authorized to access the service facility; and
initiate delivery of a security message containing a correlate of the encoded string to the service facility;
wherein the access to the service facility is granted only to calls containing an encoded string corresponding with the encoded string supplied in a respective security message.

17. An authentication site as claimed in claim 16 further comprising an authentication database that contains client authentication information and wherein the processor is further adapted to access the authentication database via an interface with a data network.

18. An authentication site as claimed in claim 16 wherein the processor is further adapted to select an authentication procedure to be performed.

19. An authentication site as claimed in claim 18 wherein the processor is further adapted to select the authentication procedure according to calling party identification information that is contained in a call set-up signaling message received at the first interface to set-up the call.

20. An authentication site as claimed in claim 17 wherein the processor is further adapted to access the authentication database to retrieve client authentication information associated with calling party identification information that is contained in a call set-up signaling message received at the first interface to set-up the call, in order to select, customize and evaluate the results of, the authentication procedure.

21. An authentication site as claimed in claim 18 wherein the processor is further adapted to use the calling party identification information, to customize the selected authentication procedure.

22. An authentication site as claimed in claim 17 wherein performing the authentication procedure comprises playing announcements that prompt the calling party to supply information, and collecting the calling party supplied information.

23. An authentication site as claimed in claim 22 wherein performing the authentication procedure comprises a step of sending at least a part of the calling party supplied information to the authentication database to be analyzed.

24. An authentication site as claimed in claim 16 wherein the processor effects the re-connection by issuing a message containing the ES that is forwarded to a switch in a call connection path of the call via the second interface.

25. An authentication site as claimed in claim 24 wherein the message containing the ES is addressed to a call control application controlling a call control node in the call connection path of the call, and the message is used by the call control application to command the call control node to disconnect the call to the authentication site and re-connect the call to the service facility.

26. An authentication site as claimed in claim 25 wherein the processor is further adapted to formulate and transmit via the second interface, the security message.

27. An authentication site as claimed in claim 26 wherein the call control application is further adapted to release the call in the event that the authentication response is negative.

28. An authentication site as claimed in claim 15 wherein the authentication site further comprises an authentication database adapted to store client authentication information.

29. An authentication site as claimed in claim 15 wherein the authentication database is further adapted to receive an authentication request message with caller supplied information, and use the information with client authentication information, to authenticate the client.

30. An authentication site as claimed in claim 28 wherein different levels of security measures are applied to the call, depending on the calling party identification information.
